(19) United States
(12) Patent Application Publication
(10) Pub. No.: US 2025/0308827 A1
(43) Pub. Date: Oct. 2, 2025

(54) CONTROL UNIT FOR AN ELECTRICAL CIRCUIT BREAKER AND ASSOCIATED ELECTRICAL CIRCUIT BREAKER

(71) Applicant: Schneider Electric Industries SAS, Rueil-Malmaison (FR)

(72) Inventors: Thomas Bianchi, Grenoble (FR); Patrick Prieur, Claix (FR); Yves Leveque, Voiron (FR)

(73) Assignee: Schneider Electric Industries SAS, Rueil-Malmaison (FR)

(21) Appl. No.: 19/089,678

(22) Filed: Mar. 25, 2025

(30) Foreign Application Priority Data
Mar. 28, 2024 (FR) 2403190

(51) Int. Cl. H01H 71/08; H01H 71/02

(52) U.S. Cl. CPC H01H 71/08; H01H 71/0214; H01H 71/0228

(57) ABSTRACT

Control Unit for an Electrical Circuit Breaker and Associated Electrical Circuit Breaker

This control unit (20) presents a front face (22) extending on a front plane (P22) where a connection housing (301), closable by a cover (308), opens and which is configured to receive a connection module (300) in an assembled position. Contact pads (36) are arranged at the bottom of the housing. The connection module presents a front face (311A) with an output connector (316). In the assembled position, the closed cover extends a creepage distance between the output connector and the front plane beyond a class 1 isolation distance under a voltage less than or equal to 690 V. In the absence of the connection module, the closed cover extends a clearance distance between each contact pad and the front plane (P22) beyond a class 2 isolation distance under a voltage greater than 690 V.

The present invention relates to a control unit for an electrical circuit breaker, as well as an electrical circuit breaker comprising such a control unit.

It is known, particularly from EP-0 843 332-A1, electrical circuit breakers including a breaker unit and an electronic control unit. Such a control unit is typically configured to measure, in real-time, the operating state of the circuit breaker and to command the opening of the breaker unit in case of a malfunction of the circuit breaker. The control unit is reversibly received in a receptacle provided in the breaker unit and is located on a front face of the circuit breaker, so that a user can read and/or adjust certain operating parameters of the electrical circuit breaker. The control unit is removable, so that a user can replace the control unit in case of malfunction, without having to disconnect the breaker unit from the rest of the electrical installation.

According to the applications, the electrical circuit breaker operates under voltages of several hundred or even thousands of Volts, and under currents up to several thousand Amperes. The electrical circuit breaker in general, and the control unit in particular, must present sufficient electrical isolation to ensure the safety of people. For example, the IEC 947-1:2019 standard—tables 13 and 15—defines isolation classes, which correspond to minimum distances to be respected between electrified points—or likely to be electrified—and the user. The isolation distances depend, in particular, on the isolation class sought, and the electrical voltage under which the electrical circuit breaker operates. In the context of the present description, two main voltage ranges are considered, with a first range corresponding to a voltage less than or equal to 690 V, and a second range corresponding to a voltage strictly greater than 690 V. For a voltage greater than 690 V, class 1 isolation requires a clearance distance—or air distance—greater than 7 mm, and creepage distances greater than 10 mm. Class 2 isolation doubles these distances. For a voltage less than 690 V, class 2 isolation requires an air distance greater than 10 mm.

EP 3 290 935-A1 describes, for example, a control unit comprising a casing made of an insulating material, in which several components are received, such as a printed circuit board, voltage division components, etc. With the evolution of technologies and needs, it is advantageous to propose, if necessary, a wired connection interface, so that the user can transfer data from and/or to the control unit. A connection interface is on one hand connected to the printed circuit board of the control unit, and on the other hand offers the user a connector, for example a USB connector, in particular, a USB-C, or a connector of another format, to which the user can connect an electronic device able to communicate with the control unit.

We are interested here in connection interfaces that are modular, that is to say, that are part of a connection module that can be connected or disconnected from the control unit.

It is known to connect to the control unit a connection module comprising a connection cable with an input connector, and a casing with an output connector. To ensure isolation distances, the connection cable is connected to the control unit from the rear, while the casing is fixed on the front face of the circuit breaker. Such a solution is impractical, as it requires removing the control unit from its receptacle to make the connection. Moreover, the casing fixed on the circuit breaker is bulky and risks being damaged.

The invention particularly aims to address these needs by proposing a control unit that allows the installation of a connection module without interruption of service, while ensuring the protection of people and remaining compact.

To this end, the invention relates to a control unit for an electrical circuit breaker, the control unit comprising a front face, which presents a generally flat shape and is geometrically carried by a front plane, the front face being orthogonal to a depth axis and defining a forward direction oriented toward the user when the control unit is in a normal use configuration, the control unit comprising:
a casing, which is made of an insulating material and in which a connection housing is provided, the connection housing being recessed from the front plane and opening onto the front plane,
a printed circuit board, which comprises a connection zone associated with the connection housing, the connection zone being located at the bottom of the connection housing and comprising several electrical contact pads,
a connection module, which is configured to be received in the connection housing in an assembled position of the connection module, the control unit being then in an assembled configuration, the connection module comprising:
   a body, which is made of an electrically insulating material, and which comprises attachment means to hold the connection module in the assembled position, the body comprising a rear face, which is located facing the connection zone when the control unit is in the assembled configuration, and a front face, which is oriented opposite the rear face,.
   an input connector, which opens onto the rear face, and which is configured to be connected to one or more of the contact pads of the connection zone,
   an output connector, which is connected to the input connector and opens onto the front face of the connection module, the output connector being able to receive a complementary connector so that a user can exchange data with the control unit,
wherein:
the contact pads are located recessed from the front plane and are spaced away from the front plane by a distance, measured according to the depth axis, greater than a predetermined first threshold,
the first threshold is chosen so that a clearance distance between each contact pad and the front plane is greater than a class 2 isolation distance under a voltage greater than 690 V, the clearance distance and the class 2 isolation distance being according to the IEC 947-1:2019 standard,
the control unit also comprises a cover, which is articulated relative to the rest of the control unit and is movable between a closed position, where the cover closes the connection housing a rear face of the cover being oriented toward the connection housing, and an open position, where the cover does not prevent access to the connection housing,
when the connection module is in the assembled position:
   the output connector is located recessed from the front plane, so that a front face of the cover is substantially aligned with the front plane, the front face of the cover being oriented opposite the rear face of the cover,.
   the cover in the closed position prevents access to the output connector, so that a creepage distance between the output connector and the front plane is greater than a class 1 isolation distance under a voltage less than or equal to 690 V, the creepage distance being according to the IEC947-1:2019 standard.

Thanks to the invention, when the intended operating voltage is less than or equal to 690 V, it is possible to equip the control unit with a connection module while ensuring the safety of the user by a sufficient isolation distance, both when the connection module is present, the isolation distance being measured from the output connector, or when the connection module is absent, the isolation distance being measured from the contact pads. The connection module is mounted from the front, without having to remove the control unit, and is received in the casing of the control unit, which thus remains compact.

According to advantageous but non-mandatory aspects of the invention, such a control unit may incorporate one or more of the following features taken in isolation or in any technically permissible combination:
The connection housing is delimited, toward the rear, by a bottom wall, which is part of the casing, which is arranged recessed, relative to the front plane according to the forward direction and in which openings are provided, the openings opening into the connection housing, and
the electrical contact pads are located on a rear side of the bottom wall and are accessible from the connection housing through the openings.
Each opening presents a profile respecting an IP3x protection index such as defined in the IEC 60529:2013 standard.
The input connector comprises telescopic pins, each telescopic pin being configured to be connected to a respective contact pad,
while in the assembled configuration of the connection module, the rear face of the connection module is pressed against the bottom wall.
The casing comprises a peripheral wall, which delimits the connection housing radially to the depth axis,
while the casing comprises a groove, which is provided recessed in the peripheral wall and which opens into the connection housing, the groove extending parallel to the depth axis,
that the body comprises a protrusion, which is configured to be received in the groove when the connection module is in the assembled position,
and that the protrusion and the groove cooperate to form a keying member of the control unit.
The control unit comprises, in addition to the connection housing, a second housing, which is provided in the casing, and which opens onto the front face of the control unit, while the groove opens into the second housing,
and that the control unit also comprises a wedge, which is configured to be inserted into the second housing in an inserted position, the wedge comprising a second protrusion, preferably a tongue, which at least partially closes the groove when the wedge is in the inserted position, preventing the assembly of the connection module in the connection housing.
The wedge in the inserted position is non-removable.

The wedge is advantageously put in place when the intended operating voltage is greater than 690 V; preventing the installation of the connection module in the control unit. The safety of the user is thus ensured by a sufficient isolation distance from the contact pads.

The invention also relates to an electrical circuit breaker, comprising:
a breaker unit, comprising at least one breaker device and an actuator,
one example of the control unit such as described above, wherein:
the breaker unit provides a receptacle, which opens onto a frontal face of the breaker unit,
the control unit is received in the receptacle, so that the front face of the control unit is substantially aligned with the frontal face of the breaker unit.

The invention will be better understood, and other advantages thereof will appear more clearly in the light of the following description of one embodiment of a control unit and an electrical circuit breaker, in accordance with its principle, given solely by way of example and made with reference to the appended drawings, wherein:

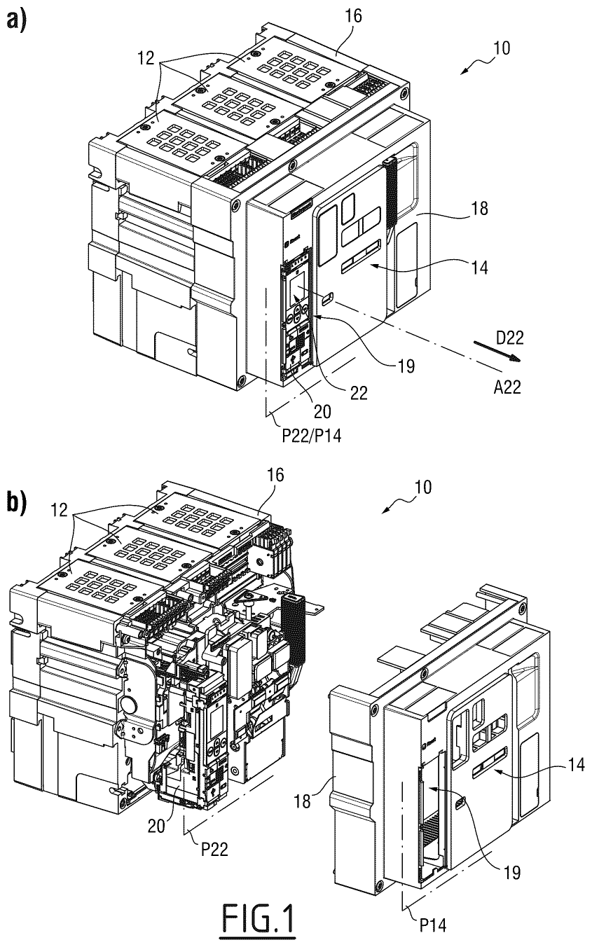

FIG. 1 respectively represents, in two inserts a) and b), a perspective view and a partially exploded perspective view of an electrical circuit breaker in accordance with the invention, the electrical circuit breaker comprising a control unit, also in accordance with the invention;

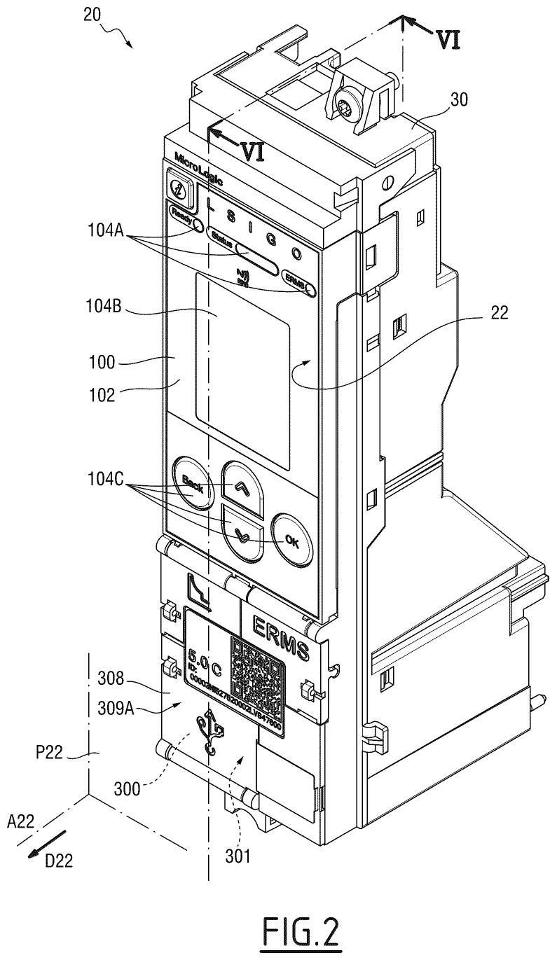

FIG. 2 is a perspective view of the control unit of FIG. 1;

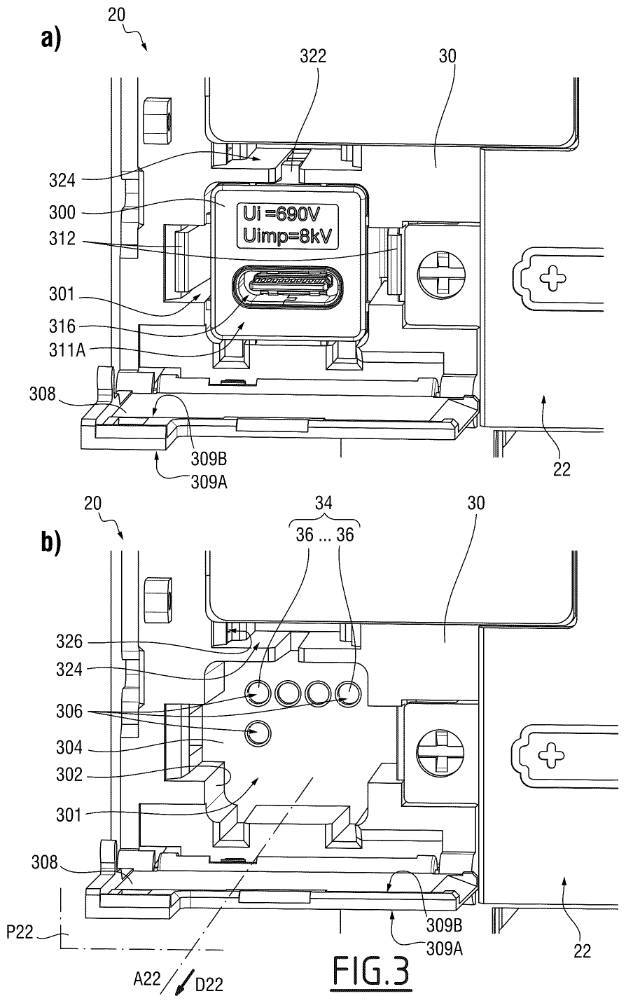

FIG. 3 represents, in two inserts a) and b), a perspective view of the control unit of FIG. 2 in two different configurations, the control unit being represented with a connection module in insert a) and without the connection module in insert b);

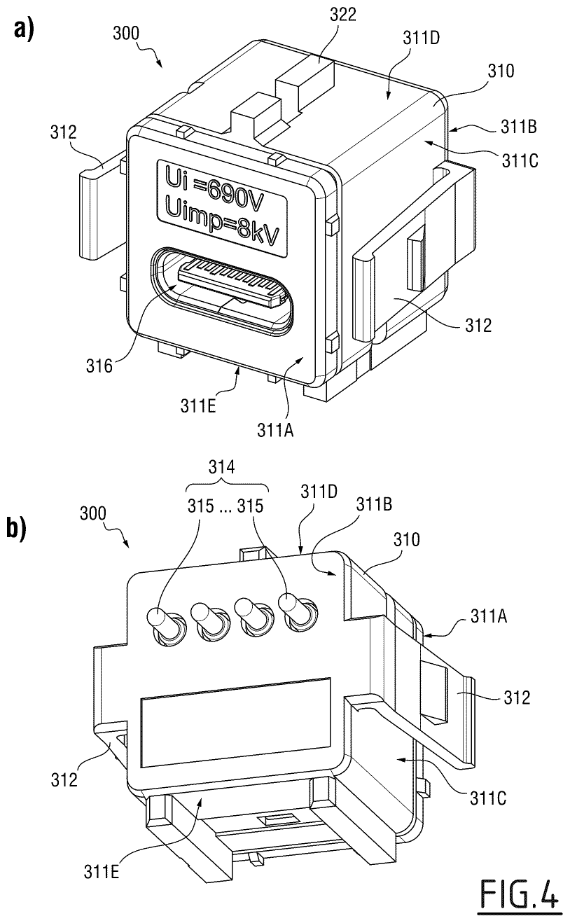

FIG. 4 respectively represents, in two inserts a) and b), a perspective view of the connection module of FIG. 3, observed, according to two opposite directions,

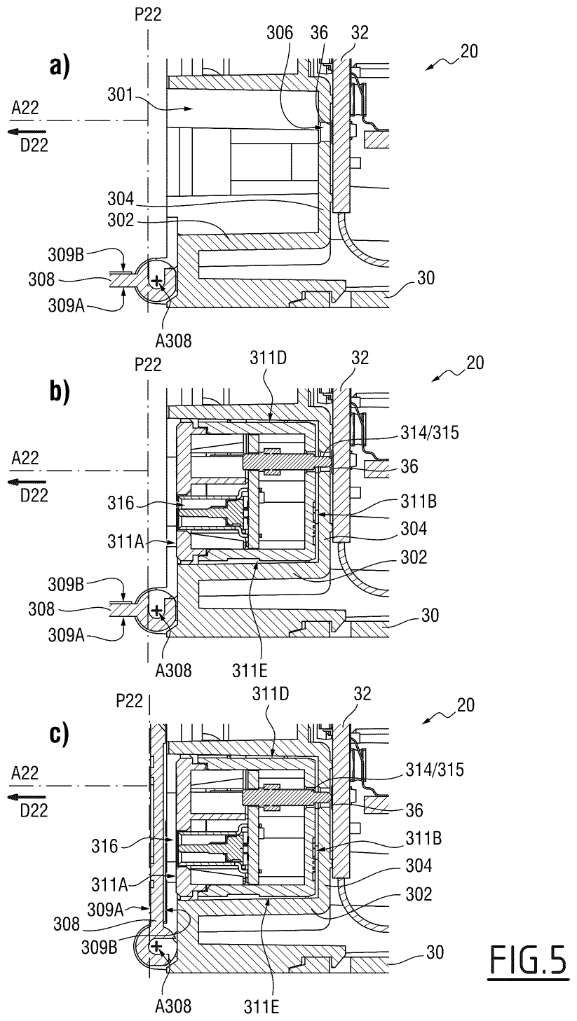

FIG. 5 represents, in three inserts a), b) and c), a section of a housing provided in the control unit and configured to receive the connection module, the control unit being represented in three different configurations;

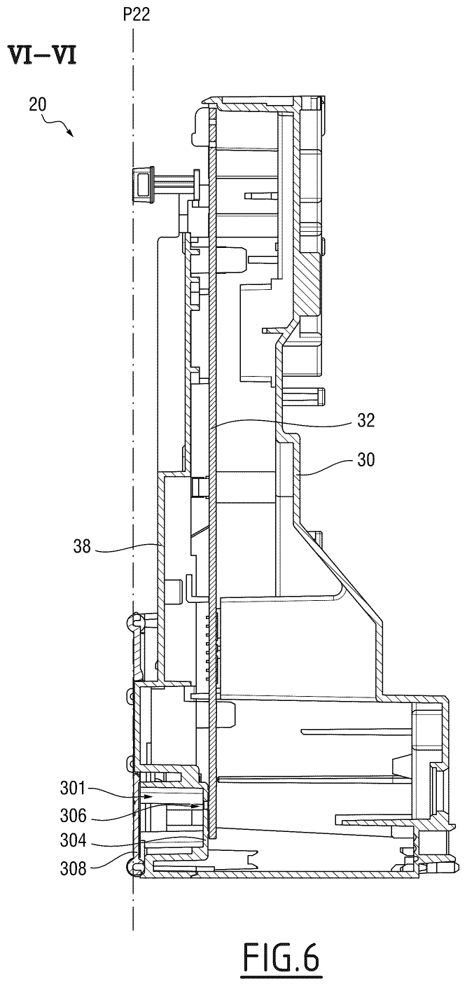

FIG. 6 is a section of the control unit of FIG. 2 according to a plane VI-VI, the connection module being hidden;

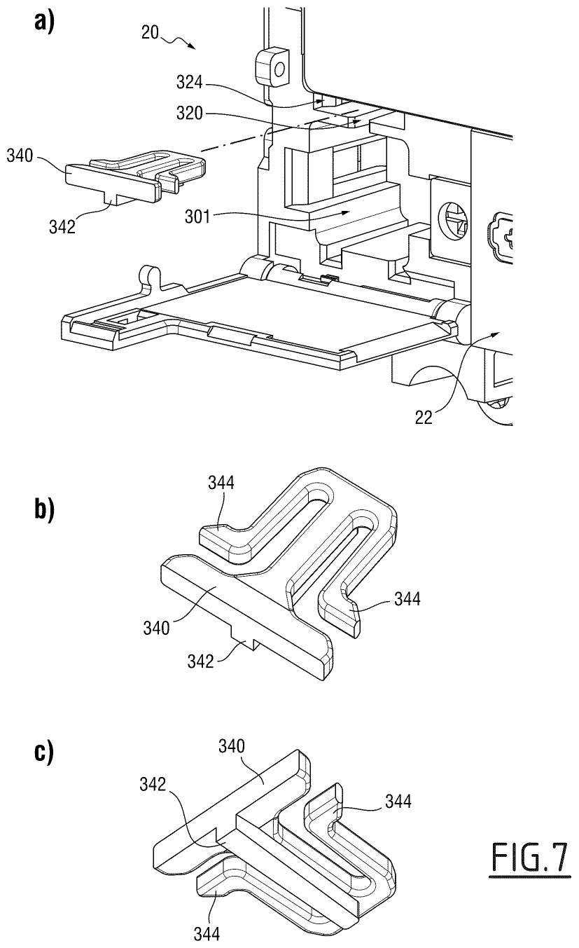

FIG. 7 represents, in three inserts a), b) and c), a perspective view of the control unit of FIG. 2 and an element of the control unit, and

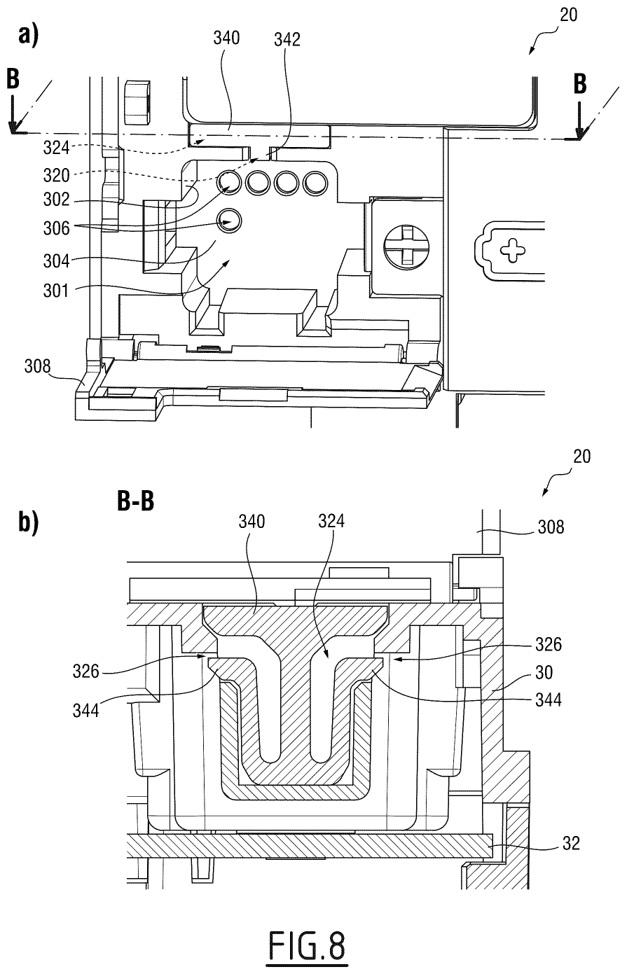

FIG. 8 respectively represents, in two inserts a) and b), a perspective view and a section of the control unit.

An electrical circuit breaker 10 is represented in FIG. 1. The electrical circuit breaker 10, also simply called circuit breaker 10, is here a multipole circuit breaker, in particular a three pole circuit breaker. The number of poles of the circuit breaker 10 is not limiting. In a known manner, a multipole electrical circuit breaker includes, for each electrical pole, input and output power terminals, which are respectively connected or electrically isolated from each other by a breaker device of the circuit breaker. The breaker device comprises, for example, separable movable contacts, which are received in a breaker chamber of the electrical circuit breaker 10 and the movements of which are controlled by an actuator. Thus, the breaker device is triggerable by the actuator. The breaker chambers are here materialized by three grids 12 visible on an upper face of the circuit breaker 10, the other elements of the breaker device not being represented.

The electrical circuit breaker 10 is intended to be used within an electrical installation, for example, to control the power supply of a machine tool. In a normal use configuration, the electrical circuit breaker 10 is generally placed within an electrical cabinet, the electrical circuit breaker 10 presenting a frontal face 14, which is oriented toward the user standing in front of the electrical cabinet. The electrical cabinet is not represented.

The electrical circuit breaker 10 comprises a breaker unit 16, which, in particular, includes each of the breaker chambers, as well as the breaker device and the associated actuator.

The electrical circuit breaker 10 advantageously comprises a cover 18, which is removable from the breaker unit 16. The cover 18 is made of an electrically insulating material and extends generally according to a frontal plane P14, which defines a portion of the frontal face 14 of the electrical circuit breaker 10, and by extension of the breaker unit 16. The cover 18 thus serves to protect the user of the circuit breaker 10. In FIG. 1 a), the cover 18 is represented assembled to the breaker unit 16, which corresponds to a normal use configuration of the circuit breaker 10. In FIG. 1 b), the cover 18 is spaced away from the breaker unit 16, this configuration being found, for example, during maintenance of the breaker unit 16.

The electrical circuit breaker 10 also comprises a control unit 20. The control unit 20 is configured to analyze the states of the breaker unit 16 and is configured to trigger the actuator based on the results of these analyses, thus separating the separable contacts.

The control unit 20 comprises a front face 22. The front face 22 presents a generally flat shape and is geometrically carried by a front plane P22, which is orthogonal to a depth axis A22 of the control unit 20. The front face 22 is oriented toward the user when the control unit 20 is in a normal use configuration. The front face 22 thus defines a forward direction D22, which is parallel to the depth axis A22. The forward direction D22 is represented by an arrow. The notions of directions such as “forward,” “backward,” “up,” “down,” etc., are defined in relation to the elements such as represented in the drawings, knowing that it may be otherwise in reality.

The cover 18 comprises a window 19, through which the front face 22 of the breaker unit 20 is visible. The window 19 is preferably closed by a transparent flap. The flap is not represented.

The control unit 20 is assembled to the breaker unit 16 in a reversible manner. In the example of FIGS. 1 a) and 1 b), the control unit 20 is represented in an assembled configuration to the breaker unit 16. The control unit 20 is represented in isolation in FIG. 2.

The breaker unit 16 provides a receptacle, which opens onto a frontal face 14 of the breaker unit 16 and in which the control unit 20 is received, so that the front face 22 of the control unit 20 is substantially aligned with the frontal face 14 of the breaker unit 16, as illustrated in particular in FIG. 1 a). The receptacle is not represented.

The control unit 20 is now described, with reference to FIGS. 2 and 3.

The control unit 20 comprises a casing 30, which is made of an insulating material, and which forms a receiving volume for various components of the control unit 20. The casing 30, in particular, houses a printed circuit board 32, which is partially visible in FIG. 3. The printed circuit board 32 comprises a printed circuit and several electronic components such as a microprocessor, a light-emitting diode, etc.

In the illustrated example, the printed circuit board 32 comprises several portions, which are, here, connected to each other by a communication bus. The communication buses are not represented. Optionally, one or more portions of the printed circuit board 32 are flexible. Alternatively, the printed circuit board 32 includes several portions that are not connected to each other by the communication buses. Alternatively, the printed circuit board 32 is in one piece.

The casing 30 includes a front sub-assembly 100. By extension, the sub-assembly 100 belongs to the control unit 20. The front sub-assembly 100 comprises a central portion 102, which is generally flat, which presents a front side 102A and a rear side 102B opposite the front side 102A. The central portion 102 is here configured to receive at least one human machine interface element 104. The front side 102A of the central portion 102 is preferably oriented according to the forward direction D22. A human machine interface is also referred to by its acronym HMI. The human machine interface elements 104 are also simply noted as “HMI elements” 104. In the illustrated example, the central portion 102 comprises several HMI elements 104. The HMI elements 104 here include three indicator lights 104A, a transparent portion 104B, through which a screen can be observed, and four buttons 104C. These examples are not limiting, the type, number, and arrangement of the HMI elements 104 can be changed during the design of the front sub-assembly 100.

The front sub-assembly 100 is assembled to the rest of the control unit 20, in particular to the casing 30, in a reversible manner. It is thus possible to replace the front sub-assembly 100 in case of malfunction. The central portion 102 thus forms a portion of the front face 22 of the control unit 120.

The control unit 20 comprises a connection module 300, which is received in a connection housing 301 provided in the rest of the control unit 20, in an assembled position of the connection module 300. By extension, the control unit 20 is in a so-called assembled configuration. The connection housing 301 is provided recessed from the front plane P22 and opens onto the front face 22.

The connection module 300 is configured to be reversibly received in the connection housing 301, the connection module 300 being configured to be inserted into the connection housing 301 according to an insertion movement, which is a movement in translation parallel to the depth axis A22 and oriented according to a rearward direction, that is to say, in a direction opposite to the forward direction D22.

The control unit 20 comprises a cover 308, which is articulated relative to the casing 30 and which closes the connection housing 301. The cover 308 is represented in a closed position in FIG. 2, and in an open position in FIG. 3, revealing the connection housing 301. In FIG. 3 a), the connection module 300 is represented in the connection housing 301, while in FIG. 3 b), the connection module is absent, revealing the connection housing 301.

The cover 308 is here articulated in rotation relative to the casing 30 around a hinge axis A308 parallel to the front plane P22. The cover 208 is thus not detachable. The cover 308 presents a generally flat shape and comprises a front face 309A and a rear face 309B, which is oriented opposite the front face 309A. When the cover 308 is in the closed position, the front face 309A is oriented according to the forward direction D22, while the rear face 309B is oriented toward the bottom wall 304.

The connection module 300 and the associated connection housing 301 are now described. The connection housing 301 is represented in perspective in FIG. 3 b) and in section in FIG. 5. The second connection module 300 is represented in isolation in FIG. 4 and in an assembled configuration in FIGS. 5 b) and 5 c).

The connection housing 301 presents a substantially cylindrical shape according to an axis parallel to the depth axis A22. The connection housing 301 is delimited by a peripheral wall 302, which delimits the connection housing 301 radially to the depth axis A22. In the illustrated example, the connection housing 301 also comprises a bottom wall 304, which delimits the connection housing 301 toward the rear. In an alternative, not represented, the bottom wall is absent. The peripheral wall 302 and the bottom wall 304 are, therefore, here, part of the casing 30. The bottom wall 304 is arranged recessed relative to the front plane P22 according to the forward direction D22 and opens onto the front plane P22.

A portion of the printed circuit board 32 is located recessed from the connection housing 301, here on the rear side of the bottom wall and comprises a connection zone 34, the connection zone 34 comprising at least one contact pad 36. Each contact pad 36 comprises a substantially flat conductive element located on the surface of the printed circuit board 32, each contact pad 36 being able to be electrically connected to a respective complementary connector belonging to the connection module 300, each complementary connector coming into contact with the corresponding contact pad 36. Advantageously, the contact pads 36 are part of the printed circuit of the printed circuit board 32, in other words, they are manufactured at the same time as the printed circuit board 32. In the illustrated example, the connection zone 34 comprises five contact pads 36.

The connection housing 301 here comprises openings 306, which are provided in the bottom wall 304 and which open into the battery housing 301. The connection zone 34 and the associated contact pads 36 are located on a rear side of the bottom wall 304 and are accessible from the connection housing 301 through the openings 306. The five contact pads 36, and by extension the second connection zone 34B, are thus associated with the second connection housing 301.

In the illustrated example, the second connection zone 34B comprises five contact pads 36, which are located on a rear side of the bottom wall 304 and which are accessible from the connection housing 301 through the openings 306.

Each opening 306 presents a profile with an inscribed circle diameter strictly less than 2.5 mm, preferably less than 2.0 mm, in order to comply with an IP3x protection index as defined in the IEC 60529:2013 standard. In the illustrated example, for each of the openings 306, the diameter of the inscribed circle is equal to 1.9 mm. This thus reduces the risk of accidental introduction of objects through the openings, reducing the risk of electrical accidents. Each of the openings 36 is preferably circular.

Each contact pad 36 of the second connection zone 34B is located recessed from the front plane P22 and is spaced away from the front plane P22 by a distance such that, when the cover 308 is in the closed position, a clearance distance between each contact pad 36 and the plane 22 is greater than a predetermined first threshold S1. The first threshold S1 is chosen so that a clearance distance between each contact pad 36 and the front plane P22 is greater than a class 2 isolation distance under a voltage greater than 690 V, the clearance distance and the class 2 isolation distance being according to the IEC947-1:2019 standard. The first threshold S1 is advantageously chosen greater than or equal to 14 mm.

The connection module 300 is now described. The connection module 300 comprises a body 310, which is made of an electrically insulating material. The body 310 here presents a generally parallelepiped shape and comprises a front side 311A, which is oriented toward the user when the connection module 300 is in the assembled position, and a rear side 311B, which is oriented opposite the side, in other words, which is located facing the second connection zone 34B when the control unit 20 is in the assembled configuration. The body 310 also comprises two lateral faces 311C, which are oriented opposite each other and which connect the front face 311A to the rear face 311B. The body 310 also comprises an upper face 311D and a lower face 311E, which are oriented opposite each other and which connect, on the one hand, the front face 311A to the rear face 311B and, on the other hand, the lateral faces 311C to each other.

The body 310 comprises attachment means 312 to hold the connection module 300 in the assembled position. The attachment means 312 are here two elastic clips, which extend from each of the lateral faces 311C. The attachment means 312 are advantageously reversible, so that a user can extract the connection module 300 from the connection housing 301, for example, to replace the connection module 300 in case of malfunction.

The connection module 300 also comprises an input connector 314, which opens onto the rear side 311B, and which is configured to be connected to one or more of the contact pads 36 of the second connection zone 34B.

The input connector 314 advantageously comprises pins 315, preferably telescopic pins-also called “pogo-pins”, each pin 315 being configured to be connected to a respective contact pad 36 according to a movement in translation. Each pin 315 is thus a complementary connector of the connection module 300, configured to be connected to a respective contact pad 36. In the assembled configuration of the connection module 300, the rear face 311B is preferably in contact with the bottom wall 304. The telescopic pins 315 allow dimensional variations to be accommodated when the connection module 300 is in the assembled position. This thus reduces the footprint of the control unit 20, while ensuring good electrical contact between the input connector 314 and the associated contact pads 36.

The connection module 300 also comprises an output connector 316. The output connector 316 is connected to the input connector 314 through the body 310 and opens onto the front face, the output connector 316 being able to receive a complementary connector so that a user can exchange data with the control unit 20. The complementary connector is not represented. The connection module 300 is thus a wired connection module. In the illustrated example, the output connector is advantageously in the so-called USB Type-C format. Other types of connectors are of course possible, as long as the space constraints are respected.

When the connection module 300 is in the assembled position, the cover 308 in the closed position prevents access to the output connector 316, the rear face 309B of the cover 308 being located facing the output connector 316.

The output connector 316 is located recessed from the front plane P22, so that when the cover 308 is in the closed position, the front face 309A is geometrically carried by the front plane P22. A creepage distance between the output connector 316 and the front plane P22 is greater than a class 1 isolation distance under a voltage less than or equal to 690 V, the creepage distance being according to the IEC947-1:2019 standard. The creepage distance between the output connector 316 and the front plane P22 is thus greater than 10 mm. When the cover 308 is closed, a clearance distance between the output connector 316 and the front plane P22 is greater than a class 1 isolation distance under a voltage less than or equal to 690 V, the clearance distance being according to the IEC947-1:2019 standard. The clearance distance between the output connector 316 and the front plane P22 is thus greater than 8 mm.

In the illustrated example, the creepage distance between the output connector 316 and the front plane P22 is equal to 11.5 mm, the cover 308 being closed, while the clearance distance is equal to 11.5 mm.

When the connection module 300 is absent, a clearance distance between the contact pads 36 of the second connection zone 34B and the front plane P22 is greater than 14 mm, while a creepage distance between the contact pads 36 of the second connection zone 34B and the front plane P22 is greater than 20 mm, the cover 308 being in the closed position.

In the illustrated example, the connection housing 301 is delimited by the bottom wall 304, while the printed circuit board 32 is located on a rear side of the bottom wall 304.

More generally, and with reference to FIG. 6, the casing 30 advantageously comprises an intermediate wall 38, which is generally parallel to the front plane P22, and which is provided recessed from the front plane P22, the printed circuit board 32 being located on a rear side of the intermediate wall 38. The bottom wall 304 delimiting the connection housing 301 is advantageously a portion of the intermediate wall 38. When it is necessary to provide an opening through a portion of the intermediate wall 38 to connect another functional module, different from the connection module 300, to another connection zone provided on the printed circuit board 32, this portion of the intermediate wall 38 is preferably located recessed from the front plane P22 and is spaced away from the front plane P22 by a distance, measured according to the depth axis A22, greater than the first threshold S1. This ensures a sufficient isolation distance between the connection zone and the user.

According to another aspect of the invention illustrated in FIGS. 7 and 8, the casing 30 advantageously comprises a groove 320, which is provided, recessed in the peripheral wall 302 and which opens into the connection housing, the groove 320 extending parallel to the depth axis A22.

The body 310 of the connection module 300 comprises a protrusion 322, for example, a tongue, which is configured to be received in the groove 320 when the connection module is in the assembled position, as illustrated in FIG. 3 a). The protrusion 322 extends in projection on the body 310, here on the upper face 311D of the body 310. The protrusion 322 and the groove 320 cooperate to form a keying member of the control unit 20, the keying feature being configured to allow the insertion of the connection module 300 into the connection housing 301 only in one position.

Advantageously, the control unit 20 comprises, in addition to the connection housing 301, a second housing 324, which is provided in the casing 30 recessed from the front plane P22 and which opens onto the front face 22 of the control unit 20. The groove 320 also opens into the second housing 324. In other words, the groove 320 forms a passage between the connection housing 301 and the second housing. The control unit 20 also comprises a wedge 340, which is configured to be received in the second housing 324 in an inserted position.

The wedge 340 comprises a second protrusion 342, preferably a tongue, which at least partially closes the groove 320 when the wedge is in the inserted position, so as to prevent the assembly of the connection module 300 in the connection housing 301 when the wedge 340 is previously received in the second housing 324.

When the wedge 340 is in the inserted position, the wedge 340 is advantageously not removable, that is to say, it is not possible to remove the wedge 340 from the second housing 324 without damaging the wedge 340 or without removing the control unit 20 from its receptacle in the breaker unit 16, to then dismantle the control unit. To this end, the wedge 340 comprises clipping means 344, here two elastic tabs, which cooperate with recesses 326 provided, recessed in the second housing 324. The insertion of the wedge 340 into the second housing 324 is advantageously done by hand and without tools.

Thus, when the control unit 20 is intended to operate under voltages greater than 690 V, the prior installation of the wedge 340 in the second housing 324 allows to prevent any subsequent attempt to install the connection module 300 in the connection housing 301, which would risk exposing the user to a risk since the distances and/or isolation classes would no longer be respected.

The embodiments and alternatives mentioned above can be combined with each other to generate new embodiments of the invention.

1. A control unit for an electrical circuit breaker, the control unit comprising a front face, which presents a generally flat shape and is geometrically carried by a front plane, the front face being orthogonal to a depth axis and defining a forward direction oriented toward the user when the control unit is in a normal use configuration, the control unit comprising:
a casing, which is made of an insulating material and wherein a connection housing is provided, the connection housing being provided, recessed from the front plane and opening onto the front plane,
a printed circuit board, which comprises a connection zone associated with the connection housing, the connection zone being located at the bottom of the connection housing and comprising several electrical contact pads,
a connection module, which is configured to be received in the connection housing in an assembled position of the connection module, the control unit being then in an assembled configuration, the connection module comprising:
a body, which is made of an electrically insulating material, and which comprises attachment means to hold the connection module in the assembled position, the body comprising a rear face, which is located facing the connection zone when the control unit is in the assembled configuration, and a front face, which is oriented opposite the rear face,.
an input connector, which opens onto the rear face and is configured to be connected to one or more of the contact pads of the connection zone,
an output connector, which is connected to the input connector and opens onto the front face of the connection module, the output connector being able to receive a complementary connector so that a user can exchange data with the control unit,
wherein:
the contact pads are located recessed from the front plane and are spaced away from the front plane by a distance, measured according to the depth axis, greater than a predetermined first threshold,
the first threshold is chosen so that a clearance distance between each contact pad and the front plane is greater than a class 2 isolation distance under a voltage greater than 690 V, the clearance distance and the class 2 isolation distance being according to the IEC 947-1:2019 standard,
the control unit also comprises a cover, which is articulated relative to the rest of the control unit and is movable between a closed position, where the cover closes the connection housing a rear face of the cover being oriented toward the connection housing, and an open position, where the cover does not prevent access to the connection housing,
when the connection module is in the assembled position:
the output connector is located recessed from the front plane, so that a front face of the cover is substantially aligned with the front plane, the front face of the cover being oriented opposite the rear face of the cover,.
the cover in the closed position prevents access to the output connector, so that a creepage distance between the output connector and the front plane is greater than a class 1 isolation distance under a voltage less than or equal to 690 V, the creepage distance being according to the IEC 947-1:2019 standard.

2. The control unit according to claim 1, wherein:
the connection housing is delimited, toward the rear, by a bottom wall, which is part of the casing, which is arranged recessed relative to the front plane according to the forward direction and in which openings are provided, the openings opening into the connection housing,
the electrical contact pads are located on a rear side of the bottom wall and are accessible from the connection housing through the openings.

3. The control unit according to claim 2, wherein:
each opening presents a profile respecting an IP3x protection index as defined in the IEC 60529:2013 standard.

4. The control unit according to claim 2, wherein:
the input connector comprises telescopic pins, each telescopic pin being configured to be connected to a respective contact pad,
in the assembled configuration of the connection module, the rear face of the connection module is in contact with the bottom wall.

5. The control unit according to claim 1, wherein:
the casing comprises a peripheral wall, which delimits the connection housing radially to the depth axis,
the casing comprises a groove, which is provided, recessed in the peripheral wall and which opens into the connection housing, the groove extending parallel to the depth axis,
the body comprises a protrusion, which is configured to be received in the groove when the connection module is in the assembled position,
the protrusion and the groove cooperate to form a keying feature of the control unit.

6. The control unit according to claim 5, wherein:
the control unit comprises, in addition to the connection housing, a second housing, which is provided in the casing, and which opens onto the front face of the control unit,
the groove opens into the second housing,
the control unit also comprises a wedge, which is configured to be inserted into the second housing, in an inserted position, the wedge comprising a second protrusion, which at least partially closes the groove when the wedge is in the inserted position, preventing the assembly of the connection module in the connection housing.

7. The control unit according to claim 6, wherein:
the wedge in the inserted position is not removable.

8. The control unit according to claim 6, wherein the second protrusion is a tongue.

9. An electrical circuit breaker, comprising:
a breaker unit, comprising at least one breaker device and an actuator,
one example of the control unit according to claim 1,
wherein:
the breaker unit provides a receptacle, which opens onto a frontal face of the breaker unit,
the control unit is received in the receptacle, so that the front face of the control unit is aligned with the frontal face of the breaker unit.
